(19) United States
(12) Patent Application Publication
(10) Pub. No.: US 2009/0079216 A1
(43) Pub. Date: Mar. 26, 2009

(54) Body assembly of a motor vehicle

(76) Inventor: Ryo Kuroda, Chiba-ken (JP)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/284,076

(22) Filed: Sep. 18, 2008

(30) Foreign Application Priority Data
Sep. 21, 2007 (JP) 2007-274431

(51) Int. Cl. B62D 39/00

(52) U.S. Cl. 296/39.1

(57) ABSTRACT

A body assembly of a motor vehicle comprises an outer body structure of a motor vehicle, an interior member disposed between the outer body structure and a passenger compartment at a predetermined distance from the outer body structure, and an inner member comprising a moisture vapor permeable metalized composite sheet comprising a sheet layer having first and second outer surfaces and at least one multi-layer coating on said first outer surface of the sheet layer, the multi-layer coating comprising a first metal coating layer having a thickness between about 15 nanometers and 200 nanometers adjacent the first outer surface of the sheet layer and an outer organic coating layer of a composition containing a metal selected from the group consisting of organic polymers, organic oligomers and combinations thereof, having a thickness between about 0.2 micrometer and 2.5 micrometers deposited on the metal layer. The metalized composite sheet is disposed within the predetermined distance between the outer body structure and the inner member such that the first metal coating layer faces the outer body structure and the distance between the metalized composite sheet and the outer body structure is at least 6 mm. The body assembly of the invention improves the thermal efficiency of automobiles by reflecting thermal radiation in and out through the roof and/or door panel modules, without increasing the risk of moisture condensations within the modules.

### BACKGROUND OF THE INVENTION

1. Field of the Invention

The present invention relates to a body assembly of a motor vehicle providing thermal barrier properties that keeps the inside of the motor vehicle cooler in the summer and warmer in the winter by reflecting radiant energy or emitting little radiant energy in and out through the roof and/or door panel modules to enhance the performance of the insulation and improve the thermal energy management of the interior structure resulting in improved energy efficiency of vehicle, without increasing the risk of moisture condensation inside the roof and/or door panel modules.

2. Description of the Related Art

A motor vehicle comprises an interior structure (passenger compartment) that is installed inside an outer body assembly having an outer body structure including a metal roof. It is known that to protect against the weather and provide good temperature regulating effect, a roof insulation structure is attached to the metal roof to buffer heat transmission to the interior structure. In the summer (warm season), some of the incident radiant energy is reflected back to the metal roof and some of the incident radiant energy is transmitted to the roof insulation structure in which some of the energy is absorbed and some of the energy is further transmitted into the interior of the passenger compartment. In the winter (cold season), radiant energy is transmitted in the reverse direction. In addition, in order to regulate the temperature of the interior structure according to the outside weather, motor vehicles are usually equipped with an air conditioning system. For the purpose of environmental protection and conservation of energy, preference is given to enhanced energy efficiency of vehicles through passive management of radiant energy over the use of energy-intensive air conditioning systems to regulate the temperature of the passenger compartment.

Attempts have been made to provide temperature regulating effect, for example, U.S. Pub. No. US 2001/0009725 A1 which discloses the inclusion of an IR-reflecting metalized substrate in a vehicle roof. However, this assembly allows thermal conduction through the roof, which is counter-productive to the objective of improved temperature regulation. Furthermore, the material should ideally prevent moisture condensation in the roof insulation structure, while at the same time providing a barrier to air and liquid water and enhancing the energy efficiency of the vehicle.

It should be evident from the discussion above, that the need exists for a material having improved moisture vapor permeability and thermal barrier properties for use in the body assembly of a motor vehicle.

### BRIEF SUMMARY OF THE INVENTION

According to a first embodiment, the present invention is directed to a body assembly of a motor vehicle comprising an outer body structure of a motor vehicle, an inner member disposed between the outer body structure and a passenger compartment at a predetermined distance from the outer body structure, and a moisture vapor permeable metalized composite sheet comprising a sheet layer having first and second outer surfaces and at least one multi-layer coating on said first outer surface of the sheet layer, said multi-layer coating comprising: a first metal coating layer having a thickness between about 15 nanometers and 200 nanometers adjacent the first outer surface of the sheet layer; and an outer organic coating layer of a composition containing a material selected from the group consisting of organic polymers, organic oligomers and combinations thereof, having a thickness between about 0.2 micrometer and 2.5 micrometers deposited on the metal layer, wherein said metalized composite sheet is disposed within said predetermined distance between said outer body structure and said inner member such that said first metal coating layer faces said outer body structure and the distance between said metalized composite sheet and said outer body structure is at least 6 mm.

### BRIEF DESCRIPTION OF THE DRAWINGS

FIG. 1 is a schematic cross-sectional view of the roof insulation within the body assembly of a motor vehicle in accordance with the prior art.

FIG. 2 is a schematic cross-sectional view of the roof insulation for arrangement within the body assembly of a motor vehicle in accordance with one embodiment of the present invention.

FIGS. 3 and 4 compare the change of temperature measured for the roof insulation structure according to the present inventions and the prior art in the summer and winter, respectively.

### DETAILED DESCRIPTION OF THE INVENTION

The terms “nonwoven fabric”, “nonwoven sheet”, “nonwoven layer”, and “nonwoven web” as used herein refer to a structure of individual strands (e.g. fibers, filaments, or threads) that are positioned in a random manner to form a planar material without an identifiable pattern, as opposed to a knitted or woven fabric. The term “fiber” is used herein to include staple fibers as well as continuous filaments. Examples of nonwoven fabrics include meltblown webs, spunbond nonwoven webs, flash spun webs, staple-based webs including carded and air-laid webs, spunlaced webs, and composite sheets comprising more than one nonwoven web.

The term “woven sheet” is used herein to refer to sheet structures formed by weaving a pattern of intersecting warp and weft strands.

The term “spunbond fibers” as used herein means fibers that are melt-spun by extruding molten thermoplastic polymer material as fibers from a plurality of fine, usually circular, capillaries of a spinneret with the diameter of the extruded fibers then being rapidly reduced by drawing and then quenching the fibers.

The term “meltblown fibers” as used herein, means fibers that are melt-spun by meltblowing, which comprises extruding a melt-processable polymer through a plurality of capillaries as molten streams into a high velocity gas (e.g. air) stream.

The term “spunbond-meltblown-spunbond nonwoven fabric” (“SMS”) as used herein refers to a multi-layer composite sheet comprising a web of meltblown fibers sandwiched between and bonded to two spunbond layers. Additional spunbond and/or meltblown layers can be incorporated in the composite sheet, for example spunbond-meltblown-meltblown-spunbond webs (“SMMS”), etc.

The term “plexifilamentary” as used herein, means a three-dimensional integral network or web of a multitude of thin, ribbon-like, film-fibril elements of random length and with a mean film thickness of less than about 4 microns and a median fibril width of less than about 25 microns. In plexifilamentary structures, the film-fibril elements are generally coextensively aligned with the longitudinal axis of the structure and they intermittently unite and separate at irregular intervals in various places throughout the length, width and thickness of the structure to form a continuous three-dimensional network. A nonwoven web of plexifilamentary film-fibril elements is referred to herein as a “flash spun plexifilamentary sheet”.

As used herein, the term “tape” refers to a flattened strand, such as flattened strands formed from a slit film.

As used herein, the term “metal” includes metal alloys as well as metals.

The term “roof module assembly” is used herein to refer to a roof for a motor vehicle, such as automobiles, trucks, trains, caravans and buses. A roof module assembly includes an outer body structure such as a metal roof, an inner member, and an interior member that forms an interior overhead surface of a passenger compartment and comprises either woven or non-woven material, such as cloth, or any other material commonly used in automotive interior as may be desired and other roof elements.

The term “door panel assembly” is used herein to refer to a body assembly for a motor vehicle that includes a side outer body structure such as a metal door, an inner member, and an interior member that forms an interior side surface of a passenger compartment and comprises either woven or non-woven material, such as cloth, or any other material commonly used in automotive interior as may be desired and other door elements.

In one embodiment, the present invention relates to a roof module assembly comprising an outer body structure and an interior member, having an inner member being positioned between the outer body structure and the interior member. The inner member is positioned in spaced relation with the outer body structure such that a gap exists between the outer body structure and the inner member. The gap is at least about 6 mm, even between about 6 mm and 20 mm. The gap and the inner member have been found to function together to improve the energy efficiency of the roof module assembly.

The inner member is a metalized moisture vapor permeable composite sheet formed by coating at least one side of a moisture vapor permeable sheet layer with at least one metal layer and at least one thin organic coating layer on the side of the metal layer opposite the sheet layer. The coatings are preferably formed under vacuum using vapor deposition techniques under conditions that substantially coat the sheet layer without significantly reducing its moisture vapor permeability. The composite sheets have high moisture vapor permeability, and good thermal barrier properties. The composite sheets can also be selected to provide a high barrier to intrusion by liquid water (high hydrostatic head), which is also important in construction end uses such as house wrap and roof lining. The balance of properties provided by the composite sheets of the present invention is superior to currently available metalized sheets used in the construction industry. The composite sheets utilized to fabricate the roof module assembly of the present invention provide thin, strong, breathable air and thermal barriers that are suitable for use in the roof module assembly. The composite sheets, when used as the inner member in the roof module assembly for a motor vehicle, are beneficial in moisture vapor permeability and thermal barrier properties resulting in the improvement of the energy efficiency of the vehicle.

The composite sheets include the following structures: Sheet/M/L2, Sheet/L1/M/L2, and Sheet/L1/M/L2/M/L3, etc. where Sheet is a moisture vapor permeable sheet layer, M is a low emissivity metal layer and L1, L2, and L3 are organic coating layers comprising an organic polymer or organic oligomer, or blends thereof. The abbreviation “L1” is used herein to refer to an optional intermediate organic coating layer that is deposited on a surface of the sheet layer prior to depositing a metal layer thereon.

The intermediate coating layer has been found to improve the thermal barrier properties of the composite sheet compared to composite sheets that do not include an intermediate coating layer. The composite sheets include at least one outer organic coating layer overlying the metal layer such as L2 and L3 in the above-described structures. In composite sheet structures having more than one metal layer, individual metal layers can be formed from the same or different metal and can have the same or different thickness. Similarly, in structures having more than one organic coating layer, the individual organic coating layers can have the same or different composition and/or thickness. Each metal layer can comprise more than one adjacent metal layers wherein the adjacent metal layers can be the same or different. Similarly, each organic layer can comprise more than one adjacent organic layer, wherein the adjacent organic layers can be the same or different. The sheet layer can be coated on one side, as in the structures described above, or on both sides such as in the following structures: L2/M/Sheet/M/L2, L2/M/L1/Sheet/L1/M/L2, etc.

In one embodiment of the present invention, one or both sides of the moisture vapor permeable sheet layer comprise a porous outer surface, such as a fibrous surface or a porous film that is coated with the organic and metal layers. The organic and metal layers are deposited on the porous surface such that only the exposed or “outer” surfaces of the fibers or film on the coated side(s) are coated, without covering the pores. This includes the internal surfaces of the walls of the interstitial spaces or pores between the fibers, as well as the fiber surfaces that are exposed when viewed from the outer surface of the sheet layer on the coated side(s); but the surfaces of fibers in the interior structure of the fabric remain uncoated.

Moisture vapor permeable sheet layers suitable for forming the roof module assembly of the present invention can have a relatively low air permeability, such as between about 5 and about 12,000 Gurley seconds, even between about 20 and about 12,000 Gurley seconds, even between about 100 and about 12,000 Gurley seconds, and even between about 400 and about 12,000 Gurley seconds, which is generally considered to provide a barrier to air infiltration. Alternately, the moisture vapor permeable sheet layer can be selected to have a relatively high air permeability, for example those sheets having a Gurley Hill air permeability of less than 5 seconds, with the air permeability falling in the Frazier air permeability range. A composite sheet with a relatively high air permeability can have a moisture vapor permeability of at least about 35 g/m²/24 hours, even at least about 200 g/m²/24 hours, even at least about 600 g/m²/24 hours, and a hydrostatic head of at least about 20 cm H₂O, even at least about 50 cm H₂O, even at least about 100 cm H₂O, and even at least about 130 cm H₂O. The composite sheet preferably has a tensile strength of at least about 35 N/cm.

Suitable moisture vapor permeable sheet layers are porous sheets, which include woven fabrics, such as sheets of woven fibers or tapes, or nonwoven fabrics, such as flash-spun plexifilamentary sheets, spunbond nonwoven sheets, spunbond-meltblown nonwoven sheets, spunbond-meltblown-spunbond nonwoven sheets, and laminates that include a nonwoven or woven fabric or scrim layer and a moisture vapor permeable film layer, such as a microporous film, a microperforated film or a moisture vapor permeable monolithic film. The starting sheet layer can comprise a moisture vapor permeable sheet that has been coated using conventional coating methods. For example, the starting sheet layer can comprise a sheet of woven tapes that has been coated with a polymeric film layer and microperforated. The sheet layer may be formed from a variety of polymeric compositions, such as, for example, polyolefins such as polypropylene or high density polyethylene, polyesters, or polyamides.

In one embodiment, the moisture vapor permeable sheet forming the composite sheet for the inner member of the roof module assembly is a flash spun plexifilamentary polyolefin sheet such as Tyvek® flash spun high density polyethylene, available from E. I. du Pont de Nemours and Company, Inc. (Wilmington, Del.). Suitable flash spun plexifilamentary film-fibril materials may be made from synthetic crystallizable, organic polymers which includes polyhydrocarbons such as linear polyethylene, stereo-regular polypropylene or polystyrene; polyethers such as polyformaldehyde; vinyl polymers such as polyvinylidene fluoride; polyamides both aliphatic and aromatic, such as polyhexamethylene adipamide and polymetaphenylene isophthalamide; polyurethanes, both aliphatic and aromatic, such as the polymer from ethylene bischloroformate and ethylene diamine; polyesters such as polyhydroxypivalic acid and polyethylene terephthalate; copolymers such as polyethylene terephthalate-isophthalate, and equivalents. The polymers should be of at least film forming molecular weight. The moisture vapor permeable sheet can be a laminate of a flash spun plexifilamentary sheet with one or more additional layers, such as a laminate comprising a flash spun plexifilamentary sheet and a melt-spun spunbond sheet. Flash spinning processes for forming web layers of plexifilamentary film-fibril strand material are disclosed in U.S. Pat. Nos. 3,081,519 (Blades et al.), 3,169,899 (Steuber), 3,227,784 (Blades et al.), 3,851,023 (Brethauer et al.), the contents of which are hereby incorporated by reference.

The moisture vapor permeable starting sheet layer can be a commercially available house wrap or roof lining product as used in the construction industry. Flash-spun plexifilamentary sheets used in building construction include Tyvek® SUPRO roof lining, Tyvek® HomeWrap®, Tyvek® CommercialWrap®. Other house wrap products suitable as the moisture vapor permeable sheet layer include Air-Guard® Buildingwrap (manufactured by Fabrene, Inc., North Bay, Ontario) which is a woven fabric of high density polyethylene slit film that is coated with white pigmented polyethylene on one side and perforated, Pinkwrap® Housewrap (manufactured by Owens Corning, Toledo, Ohio) which is a woven fabric of polypropylene slit film that is coated on one side and perforated, Pinkwrap Plus® Housewrap (manufactured by Owens Corning, Toledo, Ohio) which is a cross-ply laminated polyolefin film that is micropunctured and has a corrugated surface, Tuff Wrap® Housewrap (manufactured by Cellotex Corporation, Tampa, Fla.) which is a woven fabric of high density polyethylene film that is coated on one side and perforated, Tuff Weather Wrap® (manufactured by Cellotex Corporation, Tampa, Fla.) which is a polyolefin sheet bonded to a nonwoven scrim that has been embossed to create small dimples on the surface, Greenguard Ultra Amowrap® (manufactured by Amoco, Smyrna, Ga.) which is a woven fabric of polypropylene slit film that is coated on one side and perforated, Weathermate® Plus Housewrap (manufactured by Dow Chemical Company, Midland, Mich.) which is a non-perforated nonwoven membrane that has been coated with a clear coating, and Typar® Housewrap (manufactured by Reemay, Old Hickory, Tenn.) which is a coated spunbond polypropylene sheet.

In some cases it may be desirable to use a moisture vapor permeable sheet layer that is substantially air impermeable. For example, the moisture vapor permeable sheet layer can comprise a laminate of a nonwoven or woven fabric or scrim and a moisture vapor permeable film layer, wherein the moisture vapor permeable film layer is a microporous film or a monolithic film. Generally, one or more moisture vapor permeable film layers are sandwiched between outer nonwoven or woven fabric or scrim layers and the metal and organic coating layers are deposited on at least one of the outer layers such that an outer organic coating layer forms an outside surface of the composite sheet. In one such embodiment, a moisture vapor permeable film layer is sandwiched between two staple fiber nonwoven layers, or two continuous filament nonwoven layers, or two woven fabrics. The outer fabric or scrim layers can be the same or different.

Moisture vapor permeable monolithic (non-porous) films are formed from a polymeric material that can be extruded as a thin, continuous, moisture vapor permeable, and substantially liquid impermeable film. The film layer can be extruded directly onto a first nonwoven or woven substrate layer using conventional extrusion coating methods. Preferably, the monolithic film is no greater than about 3 mil (76 micrometers) thick, even no greater than about 1 mil (25 micrometers) thick, even no greater than about 0.75 mil (19 micrometers) thick, and even no greater than about 0.60 mil (15.2 micrometers) thick. In an extrusion coating process, the extruded layer and substrate layer are generally passed through a nip formed between two rolls (heated or unheated), generally before complete solidification of the film layer, in order to improve the bonding between the layers. A second nonwoven or woven substrate layer can be introduced into the nip on the side of the film opposite the first substrate to form a moisture vapor permeable, substantially air impermeable laminate wherein the monolithic film is sandwiched between the two substrate layers.

Polymeric materials suitable for forming moisture vapor permeable monolithic films include block polyether copolymers such as a block polyether ester copolymers, polyetheramide copolymers, polyurethane copolymers, poly(etherimide) ester copolymers, polyvinyl alcohols, or a combination thereof. Preferred copolyether ester block copolymers are segmented elastomers having soft polyether segments and hard polyester segments, as disclosed in Hagman, U.S. Pat. No. 4,739,012 that is hereby incorporated by reference. Suitable copolyether ester block copolymers include Hytrel® copolyether ester block copolymers sold by E. I. du Pont de Nemours and Company (Wilmington, Del.), and Arnitel® polyether-ester copolymers manufactured by DSM Engineering Plastics, (Heerlen, Netherlands). Suitable copolyether amide polymers are copolyamides available under the name Pebax® from Atochem Inc. of Glen Rock, N.J., USA. Pebax® is a registered trademark of Elf Atochem, S.A. of Paris, France. Suitable polyurethanes are thermoplastic urethanes available under the name Estane® from The B. F. Goodrich Company of Cleveland, Ohio, USA. Suitable copoly(etherimide) esters are described in Hoeschele et al., U.S. Pat. No. 4,868,062. The monolithic film layer can be comprised of multiple layers moisture vapor permeable film layers. Such a film may be co-extruded with layers comprised of one or more of the above-described breathable thermoplastic film materials.

Microporous films are well known in the art, such as those formed from a mixture of a polyolefin (e.g. polyethylene) and fine particulate fillers, which is melt-extruded, cast or blown into a thin film and stretched, either mono- or bi-axially to form irregularly shaped micropores which extend continuously from the top to the bottom surface of the film. U.S. Pat. No. 5,955,175 discloses microporous films, which have nominal pore sizes of about 0.2 micrometer. Microporous films can be laminated between nonwoven or woven layers using methods known in the art such as thermal or adhesive lamination.

Microperforated films are formed by casting or blowing a polymer into a film, followed by mechanically perforating the film, as generally disclosed in European Patent Publication No. EP 1 400 348 A2, which indicates that the microperforations are typically on the order of 0.1 mm to 1.0 mm in diameter.

According to the present invention, the metal and organic coating layers are deposited on a porous sheet using methods that do not substantially reduce the moisture vapor permeability of the sheet. The coatings are deposited over substantially the entire surface of the sheet material while leaving the pore openings of the material substantially uncovered. According to one embodiment of the invention, the moisture vapor permeable sheet layer comprises a fibrous nonwoven or woven fabric. Alternately, the moisture vapor permeable sheet layer can be a fabric-film laminate wherein the fabric comprises an outer surface of the laminate, or the outer surface of the laminate can be a microperforated film. The metal and organic coating layers are deposited on the fabric or microperforated film such that, in the case of a fabric, the exposed surfaces of individual fabric strands on the coated surface of the composite sheet are substantially covered while leaving the interstitial spaces or pores between the strands substantially uncovered by the coating material. By “substantially uncovered” is meant that at least 35% of the interstitial spaces between the fibers are free of coating. In one embodiment, the total combined thickness of the organic coating layers is less than the diameter of the fibers of the nonwoven web. For non-fibrous sheets, at least 35% of the surface pores on the sheet surface are substantially uncovered. This provides a coated composite sheet that has a moisture vapor permeability that is at least about 80%, even at least about 85%, and even at least about 90% of the moisture vapor permeability of the starting sheet material.

When comparing the moisture vapor permeability of a coated composite sheet to the moisture vapor permeability of the uncoated starting sheet, the starting sheet used as the control should be substantially equivalent to the starting sheet material used to make the specific composite sheet for which the moisture vapor permeability is being compared. For example sheet samples from the same roll, lot, etc. used to make the coated sheet should be used to measure the moisture vapor permeability of the starting sheet. A section of the sheet layer can be masked prior to coating so that the masked section is not coated during the coating process, and measurements made on samples taken from adjacent uncoated and coated portions of the sheet. Alternately, uncoated samples can be taken from the beginning and/or the end of a roll of the sheet layer and compared to coated samples made from the same roll.

Since the coatings are discontinuous over the pores, the moisture vapor permeability is not impacted significantly. Vacuum vapor deposition methods known in the art are preferred for depositing the metal and organic coatings. The thickness of the metal and organic coatings are preferably controlled within ranges that provide a composite sheet having an emissivity no greater about 0.15, even no greater than about 0.12, and even no greater than about 0.10.

The thickness and the composition of the outer organic coating layer are selected such that, in addition to not substantially changing the moisture vapor permeability of the sheet layer, it does not significantly increase the emissivity of the metalized substrate. The outer organic coating layer preferably has a thickness between about 0.2 μm and 2.5 μm, which corresponds to between about 0.15 g/m² to 1.9 g/m² of the organic coating material. In one embodiment, the outer coating layer has a thickness between about 0.2 μm and 1.0 μm (about 0.15 g/m² to 0.76 g/m²), or between about 0.2 μm and 0.6 μm (about 0.15 g/m² to 0.46 g/m²). When an intermediate coating layer is used, the combined thickness of the intermediate and outer organic layers is preferably no greater than about 2.5 μm, even no greater than about 2.0 μm, even no greater than about 1.5 μm so that the pores on the surface of the moisture vapor permeable sheet are substantially uncovered. In one embodiment, the combined thickness of the intermediate and outer organic coating layers is no greater than about 1.0 μm. For the structure Sheet/L1/M/L2, the intermediate coating layer preferably has a thickness between about 0.02 μm and 2 μm, corresponding to between about 0.015 g/m² and 1.5 g/m². In one embodiment, the intermediate coating layer has a thickness between about 0.02 μm and 1 μm (0.015 g/m² and 0.76 g/m²), or between about 0.02 μm and 0.6 μm (0.015 g/m² and 0.46 g/m²). When additional metal and organic layers are deposited, the thickness of each organic coating layer is adjusted such that the total combined thickness of all the organic coating layers is no greater than about 2.5 μm, or no greater than about 1.0 μm. If the outer organic coating layer is too thin, it may not protect the metal layer from oxidation, resulting in an increase in emissivity of the composite sheet. If the outer organic coating layer is too thick, the emissivity of the composite sheet can increase, resulting in lower thermal barrier properties.

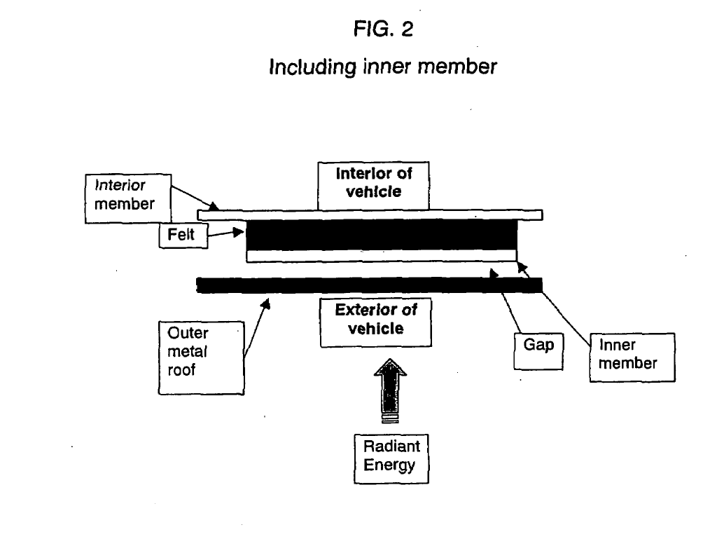

It may be desirable in some cases for the intermediate organic coating layer to be very thin, for example between about 0.02 μm and 0.2 μm (approximately 0.015 g/m² to 0.15 g/m²). One such example is when the sheet layer comprises a flash spun plexifilamentary or other nonwoven sheet wherein the plexifilaments or fibers have features on their surface that are on the order of 500 nm or less. This is much finer than the surface “macro-roughness” of the nonwoven sheet, where the macro-roughness features are caused by the fibers themselves (peaks and valleys) and gaps between the fibers. FIG. 2A is an atomic force micrograph (AFM) showing the surface features caused by the amorphous areas (dark) and the crystalline lamellae on the surface of a single uncoated high density polyethylene plexifilament. The crystalline lamellae are approximately 25 nm thick and 120 to 450 nm long. It is important that the macro-roughness of the sheet is not significantly altered by metallization and coating, because doing so results in reducing or blocking of the interstitial spaces between the fibers and a reduction in the moisture vapor permeability of the sheet. A very thin polymer layer will smooth the micro-roughness that exists on the surface of the individual fibers without impacting the macro-roughness of the fibrous sheet. In the case of flash spun polyethylene, the coating layer would need to be at least as thick as the lamellar crystallites of polyethylene, which are approximately 25 nm thick.

Suitable compositions for the organic coating layer(s) include polyacrylate polymers and oligomers. The coating material can be a cross-linked compound or composition. Precursor compounds suitable for preparing the organic coating layers include vacuum compatible monomers, oligomers or low MW polymers and combinations thereof. Vacuum compatible monomers, oligomers or low MW polymers should have high enough vapor pressure to evaporate rapidly in the evaporator without undergoing thermal degradation or polymerization, and at the same time should not have a vapor pressure so high as to overwhelm the vacuum system. The ease of evaporation depends on the molecular weight and the intermolecular forces between the monomers, oligomers or polymers. Typically, vacuum compatible monomers, oligomers and low MW polymers useful in this invention can have weight average molecular weights up to approximately 1200. Vacuum compatible monomers used in this invention are preferably radiation polymerizable, either alone or with the aid of a photoinitiator, and include acrylate monomers functionalized with hydroxyl, ether, carboxylic acid, sulfonic acid, ester, amine and other functionalities. The coating material may be a hydrophobic compound or composition. The coating material may be a crosslinkable, hydrophobic and oleophobic fluorinated acrylate polymer or oligomer, according to one preferred embodiment of the invention. Vacuum compatible oligomers or low molecular weight polymers include diacrylates, triacrylates and higher molecular weight acrylates functionalized as described above, aliphatic, alicyclic or aromatic oligomers or polymers and fluorinated acrylate oligomers or polymers. Fluorinated acrylates, which exhibit very low intermolecular interactions, useful in this invention can have weight average molecular weights up to approximately 6000. Preferred acrylates have at least one double bond, and preferably at least two double bonds within the molecule, to provide high-speed polymerization. Examples of acrylates that are useful in the coating of the present invention and average molecular weights of the acrylates are described in U.S. Pat. No. 6,083,628 and WO 98/18852.

Metals suitable for forming the metal layer(s) of the composite sheets of the present invention include aluminum, gold, silver, zinc, tin, lead, copper, and their alloys. The metal alloys can include other metals, so long as the alloy composition provides a low emissivity composite sheet. Each metal layer has a thickness between about 15 nm and 200 nm, or between about 30 nm and 60 nm. In one embodiment, the metal layer comprises aluminum having a thickness between about 15 and 150 nm, or between about 30 and 60 nm. Methods for forming the metal layer are known in the art and include resistive evaporation, electron beam metal vapor deposition, or sputtering. If the metal layer is too thin, the desired thermal barrier properties will not be achieved. If the metal layer is too thick, it can crack and flake off. Generally it is preferred to use the lowest metal thickness that will provide the desired thermal barrier properties. The metal layer reflects infrared radiation or emits little infrared radiation, providing a thermal barrier that reduces energy loss and keeps the interior of the vehicle cooler in the summer and warmer in the winter.

The thermal barrier properties of a material can be characterized by its emissivity. Emissivity is the ratio of the power per unit area radiated by a surface to that radiated by a black body at the same temperature. A black body therefore has an emissivity of one and a perfect reflector has an emissivity of zero. The lower the emissivity, the higher the thermal barrier properties. Each metal layer and adjacent outer organic coating layer is preferably deposited sequentially under vacuum without exposure to air or oxygen so that there is no substantial oxidation of the metal layer. Polished aluminum has an emissivity between 0.039-0.057, silver between 0.020 and 0.032, and gold between 0.018 and 0.035. A layer of uncoated aluminum generally forms a thin aluminum oxide layer on its surface upon exposure to air and moisture. The thickness of the oxide film increases for a period of several hours with continued exposure to air, after which the oxide layer reaches a thickness that prevents or significantly hinders contact of oxygen with the metal layer, reducing further oxidation. Oxidized aluminum has an emissivity between about 0.20-0.31. By minimizing the degree of oxidation of the aluminum by depositing the outer organic coating layer prior to exposing the aluminum layer to the atmosphere, the emissivity of the composite sheet is significantly improved compared to an unprotected layer of aluminum.

The outer organic coating layer also protects the metal from mechanical abrasion during roll handling, transportation and end-use installation.

The method for vapor-deposition coating of a sheet layer with organic and metal layers under vacuum is more particularly described in United States patent published patent US2006/0040091.

In another embodiment, the present invention relates to a door panel assembly comprising an inner member, being positioned between the outer body structure and the interior member in spaced relation with the outer body structure, as described above. The inner member is a metalized moisture vapor permeable composite sheet formed as described above.

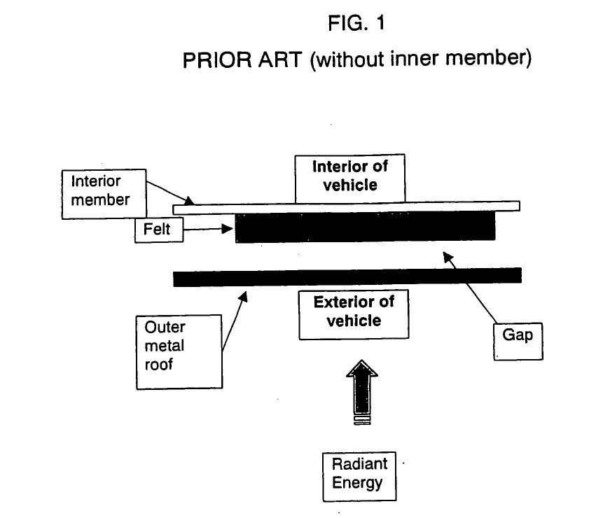

FIG. 1 illustrates a comparative example of the roof module assembly of the prior art in which no metalized composite sheet is installed as an inner member, and a layer of felt is installed between the interior member and the outer metal roof. There is an air space between the interior member and the outer metal roof.

FIG. 2 is a schematic diagram of a body assembly for a motor vehicle of the present invention, illustrating an example of the roof module assembly of the present invention in which a metalized composite sheet is installed as an inner member between the felt layer and the outer metal roof, and which is moisture vapor permeable and includes a sheet layer coated with metal and organic coating layers. The inner member can be installed such that the metalized side faces the interior and/or exterior. A gap exists between the inner member and the outer metal roof. The gap can comprise air or a thermally insulating material (not heat conductive) such as, for example, foam or fibrous insulation. The body assembly illustrated in FIG. 1 can also be used as a door panel assembly.

### Test Methods

In the non-limiting examples that follow, the following test methods were employed to determine various reported characteristics and properties. ASTM refers to the American Society of Testing Materials. ISO refers to the International Standards Organization. TAPPI refers to Technical Association of Pulp and Paper Industry.

Basis Weight was determined by ASTM D-3776, which is hereby incorporated by reference.

Thickness was determined by ASTM D1777, which is hereby incorporated by reference.

Temperature in the roof assembly (between the ceiling member and the felt layer) was measured over time using two thermocouples placed between the interior member and the felt layer.

### EXAMPLES

The abbreviations defined below are used in the Examples that follow:

Monomer/oligomer compositions:
1. TRPGDA=tripropylene glycol diacrylate
2. SR606=reactive polyester diacrylate
3. SR9003=propoxylated neopentyl glycol diacrylate
4. HDODA20%C18=a mixture of hexanediol diacrylate and stearic acid monoacrylate (80/20 by weight)
5. Zonyl® TM/TRPGDA=80/20 by weight Zonyl®TM/TRPGDA where Zonyl®TM is a fluorinated methacrylate oligomer

TRPGDA, SR606, SR9003, HDODA, and stearic acid monoacrylate are commercially available from Sartomer Company (Exton, Pa.).

Zonyl®TM fluorinated methacrylate oligomer is available from E. I. du Pont de Nemours and Company (Wilmington, Del.). The above abbreviations are also used in the Examples for the polyacrylate layer formed by curing the corresponding monomer.

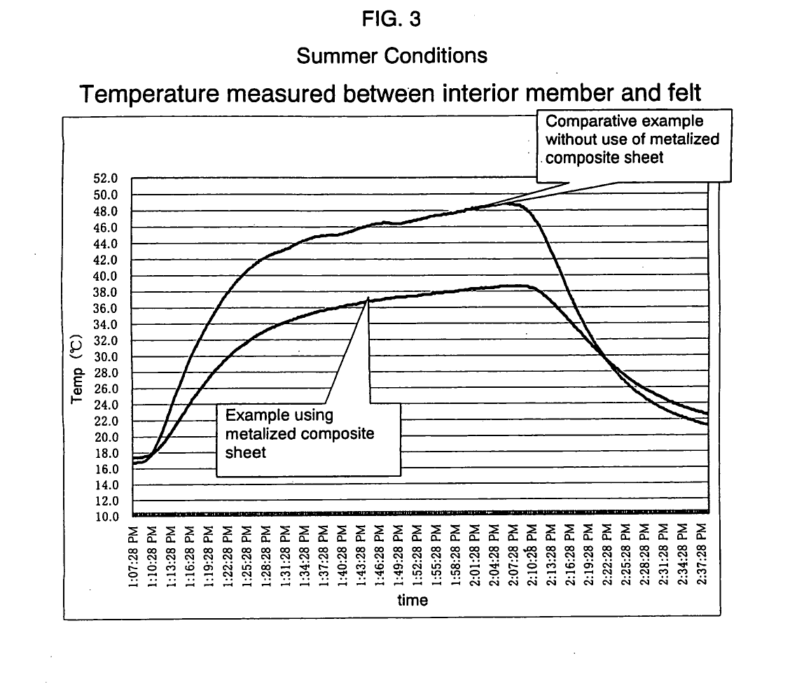

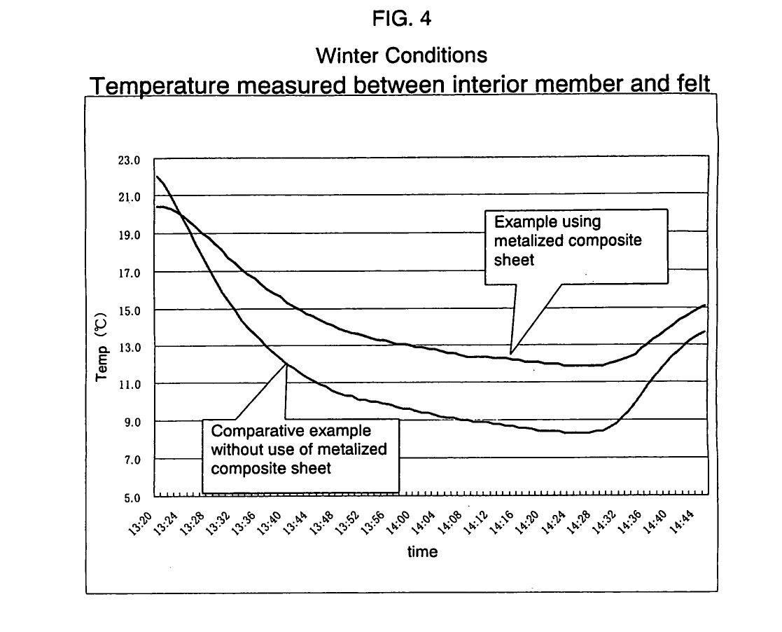

Two roof module assemblies were made, both without an inner member according to the prior art and including an inner member according to the invention, as depicted in FIGS. 1 and 2, respectively. Tyvek® Reflex® 3460M metalized house wrap available from E. I. du Pont de Nemours and Company (Wilmington, Del.), having a basis weight of 62 g/m² and a thickness of 185 μm, was used as the inner member. The Tyvek® Reflex® house wrap was metalized with an approximately 36 nm thick aluminum layer having a composite optical density of 2.5 and coated with a 1.5 g/m² organic lacquer coating using flexographic printing methods. The roof module assemblies were exposed to simulated summer and winter conditions. The outer steel surface was heated with electronic heaters to about 72° C. to simulate summer conditions, and was cooled with dry ice to about −6° C. to simulate winter conditions. The temperature between the interior (ceiling) member and the felt layer was measured over time and the results are plotted in FIGS. 3 (summer) and 4 (winter). The results indicate that the use of the inner member according to the invention keeps the interior portion of the roof module assembly cooler in the summer and warmer in the winter.

What is claimed is:

1. A body assembly of a motor vehicle comprising:
an outer body structure of a motor vehicle;
an interior member disposed between the outer body structure and a passenger compartment at a predetermined distance from the outer body structure;
an inner member comprising a moisture vapor permeable metalized composite sheet comprising a sheet layer having first and second outer surfaces and at least one multi-layer coating on said first outer surface of the sheet layer, said multi-layer coating comprising: a first metal coating layer having a thickness between about 15 nm and 200 nm adjacent the first outer surface of the sheet layer; and an outer organic coating layer of a composition containing a material selected from the group consisting of organic polymers, organic oligomers and combinations thereof, having a thickness between about 0.2 micrometer and 2.5 micrometers deposited on the metal layer; and
a gap between said metalized composite sheet and said outer body structure of at least 6 mm;
wherein said inner member is disposed within said predetermined distance between said outer body structure and said interior member.

2. The body assembly of claim 1 wherein the sheet layer comprises at least one of a nonwoven fabric, woven fabric, nonwoven fabric-film laminate, woven fabric-film laminate, moisture vapor permeable film and composites thereof.

3. The body assembly of claim 1 wherein the outer body structure is a roof and the interior member is a ceiling member.

4. The body assembly of claim 1 wherein the outer body structure is a door and the interior member is an interior door panel.

5. The body assembly of claim 1 wherein the distance between said metalized composite sheet and said outer body structure is between about 6 mm and about 20 mm.

6. The body assembly of claim 1 wherein said gap comprises air.

7. The body assembly of claim 1 wherein said gap comprises a thermally insulating material.

8. The body assembly of claim 1 further comprising an insulating material between said metalized sheet and said interior member.
